(19) United States
(12) Patent Application Publication
(10) Pub. No.: US 2019/0101665 A1
(43) Pub. Date: Apr. 4, 2019

(54) Wettability of Formations with Heavy Oil

(71) Applicant: SCHLUMBERGER TECHNOLOGY CORPORATION, Sugar Land, TX (US)

(72) Inventors: Andrea Valori, Al-Khobar (SA); Reza Taherian, Missouri City, TX (US); Wael Abdallah, Al-Khobar (SA); Farhan Ali, Dammam/Doha Camp (SA); Mohammed Badri, Al-Khobar (SA)

(21) Appl. No.: 15/724,056

(22) Filed: Oct. 3, 2017

(51) Int. Cl. G01V 3/32

(52) U.S. Cl. CPC G01V 3/32

(57) ABSTRACT

A measurement device makes measurements on a region of investigation in which a native fluid or complex fluid (e.g., emulsified fluid) has been replaced by a fluid of different viscosity. Various methods such as core flooding, pressure cycling, centrifuging, or imbibition may be used to replace the native fluid. The replacement fluid may include alkanes, alkenes, or some combination of those, and is preferably non-polar. The replacement fluid may mix with the native fluid within the pores to produce a mixture having a different viscosity than the native fluid. Measurements can be made on a sample in a lab or on an isolated region of a subsurface formation. Standard measurement techniques such as the Amott-Harvey technique or the United States Bureau of Mines technique may be used. Alternatively, NMR measurements may be performed. A parameter such as wettability and relaxivity is estimated using data obtained by the measurement device.

### BACKGROUND

There are many important petrophysical parameters used to interpret fluid flow in reservoirs and for calibrating appropriate reservoir simulation models. Among these are relative permeability, capillary pressure, saturation, spontaneous displacement, wettability, relaxivity, and resistivity, to name a few. In general, any one of these parameters can have different values during different modes of production such as the primary drainage mode, the imbibition mode, and the secondary drainage mode. The various parameter values for those different modes are conventionally determined (if at all) in the lab.

The high viscosity of certain hydrocarbons (e.g., “heavy” oil) can cause difficulties during wettability measurements. Specifically, such difficulties can arise when performing the well-known United States Bureau of Mines (USBM) and Amott Harvey (AH) techniques, where flow of oil (i.e., the fluid of interest) is a required step in either measurement. It also applies to nuclear magnetic resonance (NMR) based techniques, where the short T₂ (transverse relaxation time) of oil makes it difficult, if not impossible, to measure the diffusion signal.

There are many different existing techniques to measure wettability. The original USBM technique claims that the derived wettability index is independent of oil viscosity. This is generally true, but only within certain limits. However, no maximum usable oil viscosity for a USBM wettability measurement has been established. One investigation applying the USBM wettability measurement to a highly viscous fluid attempted to determine the wettability of an unconsolidated sand containing bitumen having a viscosity of 50,000 cP. However, it clearly stated in the report that “Heating was necessary to mobilize the viscous bitumen.” Such heating is not a common procedure for the USBM technique and can affect some properties of the fluid.

Certain NMR-based investigations, although not stating clearly the viscosities of the oils used, show the T₂ response from the bulk oils (outside the pore space) in the range of hundreds of milliseconds to several seconds, leading one to infer that the oils investigated and measured ranged from light to very light. Therefore, those investigations shed no light on how to measure wettability when heavy oil is the fluid of interest. Alternative ways to extract wettability are based on other NMR techniques. One example is a technique that looks at the T₂ shift. This approach is based on the observation that interactions between the pore fluids and the pore surfaces decrease the measured T₂ response (the NMR T₂ from any fluid in the pore space of a porous medium is always shorter than the bulk T₂ of the same fluid). The degree of relaxation enhancement can be quantified and used to obtain wettability. Still another approach uses the position of the oil peak on a Diffusion-T₂ correlation map to estimate wettability.

### SUMMARY

A measurement device makes measurements on a region of investigation in which a native fluid or complex fluid (e.g., emulsified fluid) has been replaced by a fluid of different viscosity. Various methods such as core flooding, pressure cycling, centrifuging, or imbibition may be used to replace the native fluid. The replacement fluid may include alkanes, alkenes, or some combination of those, and is preferably non-polar. The replacement fluid may mix with the native fluid within the pores to produce a mixture having a different viscosity than the native fluid. Measurements can be made on a sample in a lab or on an isolated region of a subsurface formation. Standard measurement techniques such as the Amott-Harvey technique or the United States Bureau of Mines technique may be used. Alternatively, NMR measurements may be performed. A parameter such as wettability and relaxivity is estimated using data obtained by the measurement device.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. Embodiments are described with reference to the following figures. The same numbers are generally used throughout the figures to reference like features and components.

FIG. 1 is an exemplary graph of capillary pressure versus saturation, as known in the prior art and used to calculate USBM and AH wettabilities;

FIG. 2 is a plot of T₂ distributions for a heavy oil in bulk, light oil in bulk, and water in bulk, in accordance with the present disclosure;

FIG. 3 is a schematic drawing of an NMR instrument disposed in a wellbore penetrating a formation having viscous fluid in its pores, in accordance with the present disclosure;

FIG. 4 is a schematic drawing of an alternative NMR instrument disposed and eccentered in a wellbore penetrating a formation having viscous fluid in its pores, in accordance with the present disclosure;

FIG. 5 is a plot of T₂ distributions for heavy oil in bulk and heavy oil in rock, in accordance with the present disclosure;

FIG. 6 is a plot of T₂ distributions for a heavy oil in rock, water in rock, and their composite signal, in accordance with the present disclosure;

FIG. 7 is a plot of T₂ distributions for wetting water in rock, a light hydrocarbon mixture in (at least partially) oil wet rock, and the light hydrocarbon mixture in water wet rock, in accordance with the present disclosure;

FIG. 8 is a flowchart to replace a bulk phase with a different phase without affecting a desired parameter being estimated, in accordance with the present disclosure; and

FIG. 9 illustrates an example computing system usable for one or more disclosed embodiments, in accordance with the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

Some embodiments will now be described with reference to the figures. Like elements in the various figures may be referenced with like numbers for consistency. In the following description, numerous details are set forth to provide an understanding of various embodiments and/or features. However, it will be understood by those skilled in the art that some embodiments may be practiced without many of these details and that numerous variations or modifications from the described embodiments are possible. As used here, the terms “above” and “below”, “up” and “down”, “upper” and “lower”, “upwardly” and “downwardly”, and other like terms indicating relative positions above or below a given point or element are used in this description to more clearly describe certain embodiments. However, when applied to equipment and methods for use in wells that are deviated or horizontal, such terms may refer to a left to right, right to left, or diagonal relationship, as appropriate. It will also be understood that, although the terms first, second, etc. may be used herein to describe various elements, these elements should not be limited by these terms. These terms are only used to distinguish one element from another.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

A system and method to replace a bulk phase with a different phase of different viscosity without affecting a desired parameter being estimated, such as the wettability of a rock surface, is described herein. While the disclosure herein refers to measurements on heavy oil, the scope of the invention is not limited to just heavy oil cases, but applies to all cases in which the bulk properties of the fluid of interest make it difficult to measure the wettability. Furthermore, the technique is not limited just to wettability. Another example is estimating the surface relaxivity. Determining wettability and relaxivity are example applications and are not to be considered an exhaustive list of potential applications of the system and method disclosed herein.

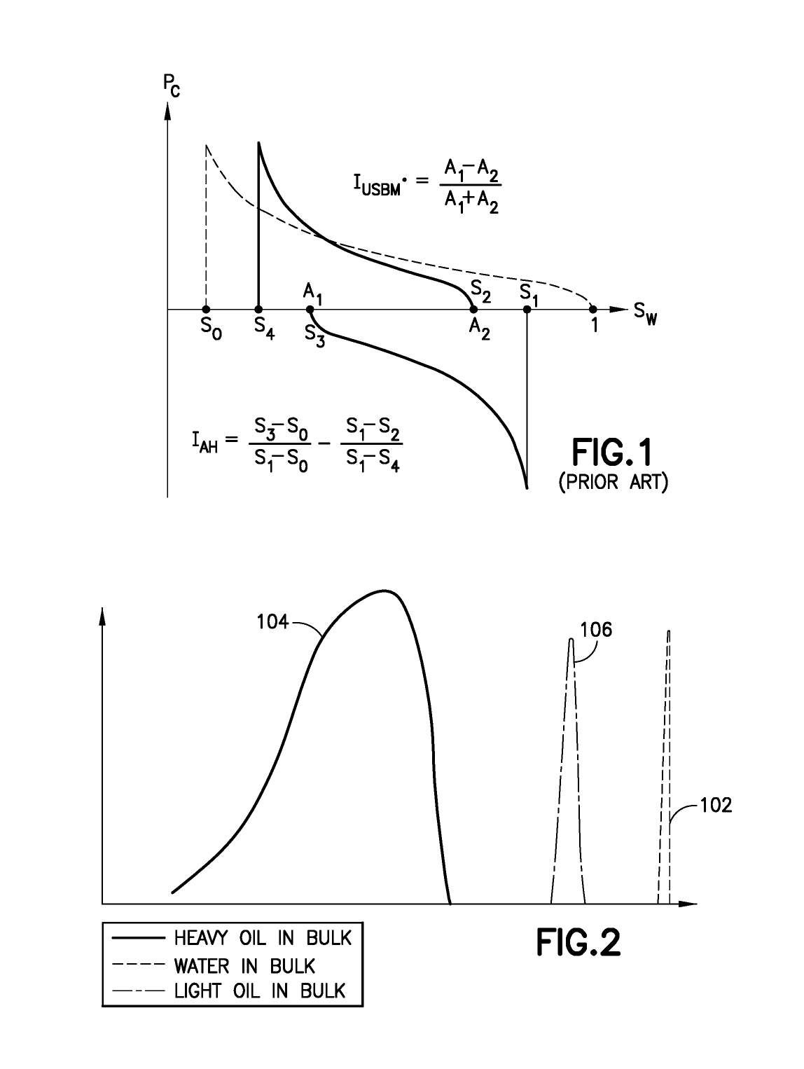

As stated above, the wettability of the rock comprising a core sample is conventionally determined using the Amott-Harvey (AH) or United States Bureau of Mines (USBM) techniques (see FIG. 1). Both techniques are based on monitoring volumes of fluids produced from core samples during successive changes in oil and water saturation. Those changes in saturation are typically brought about by spontaneous and/or forced imbibition and drainage processes. If the oil saturating the rock is heavy oil, its high viscosity reduces its mobility, limiting the volumes of oil produced to very small amounts, in extreme cases to zero. Limited oil production causes the USBM and AH wettability estimates to be inaccurate, while zero production will make the wettability index impossible to compute. For example, zero oil production can be interpreted as an “oil wet” condition for the rock examined, while the lack of production may have actually been due to the high viscosity (and associated immobility) of the oil rather than the surface wettability.

NMR-based wettability techniques rely on the fact that a fluid in a porous medium, when it is wetting, experiences an enhancement of relaxation compared to the corresponding bulk fluid. High viscosity means low mobility of the oil molecules, leading to intrinsically short T₂ values for the oil. In the “T₂ shift” approach to measure wettability, the shift is caused by the surface relaxation, which is in fast exchange with the oil in the middle of the pore. The equation describing this phenomenon for water is:

$$\frac{1}{{T}_{2 , obs , w}} = \frac{1}{{T}_{2 , bulk , w}} + {ρ}_{w} \frac{{A}_{r - w}}{{VS}_{w}} \qquad ( 1 )$$

where the left member is the observed (measured) value of T₂ and the right terms are the bulk and surface components. The surface component is a function of the rock-to-water relaxivity ρ_{w}, the area of contact A_{r-w} between the fluid and the rock, the volume V of the pore, and the water saturation S_{w} for the pore.

An analogous equation applies to the oil phase:

$$\frac{1}{{T}_{2 , obs , o}} = \frac{1}{{T}_{2 , bulk , o}} + {ρ}_{o} \frac{{A}_{r - o}}{{VS}_{o}} \qquad ( 2 )$$

where the variables are similarly defined for oil.

If a pore fluid does not wet the surface of the rock (pore), the area of contact factor vanishes and the fluid relaxes at its bulk relaxation rate. FIG. 2 shows typical T₂ distributions for three bulk fluids: water (curve 102), a heavy oil (curve 104), and a light, refined oil (curve 106). Note the crude (heavy) oil (curve 104) comes in at much shorter T₂ times than the refined oil (curve 106), and also its T₂ distribution (curve 104) is much wider than that of the light oil (curve 106).

For heavy oil in rock, since T_{2,bulk,o} is small, the bulk term 1/T_{2,bulk,o} in Equation 2 dominates the sum, even if the oil strongly wets the rock. In this case, the observed T₂ for the heavy oil in the rock is very close to (i.e., negligibly different from) the heavy oil bulk response, as shown in FIG. 5. Because of this, it is difficult, if not impossible, to distinguish whether the oil is wetting the rock or not, because one cannot extract the surface term from Equation (2).

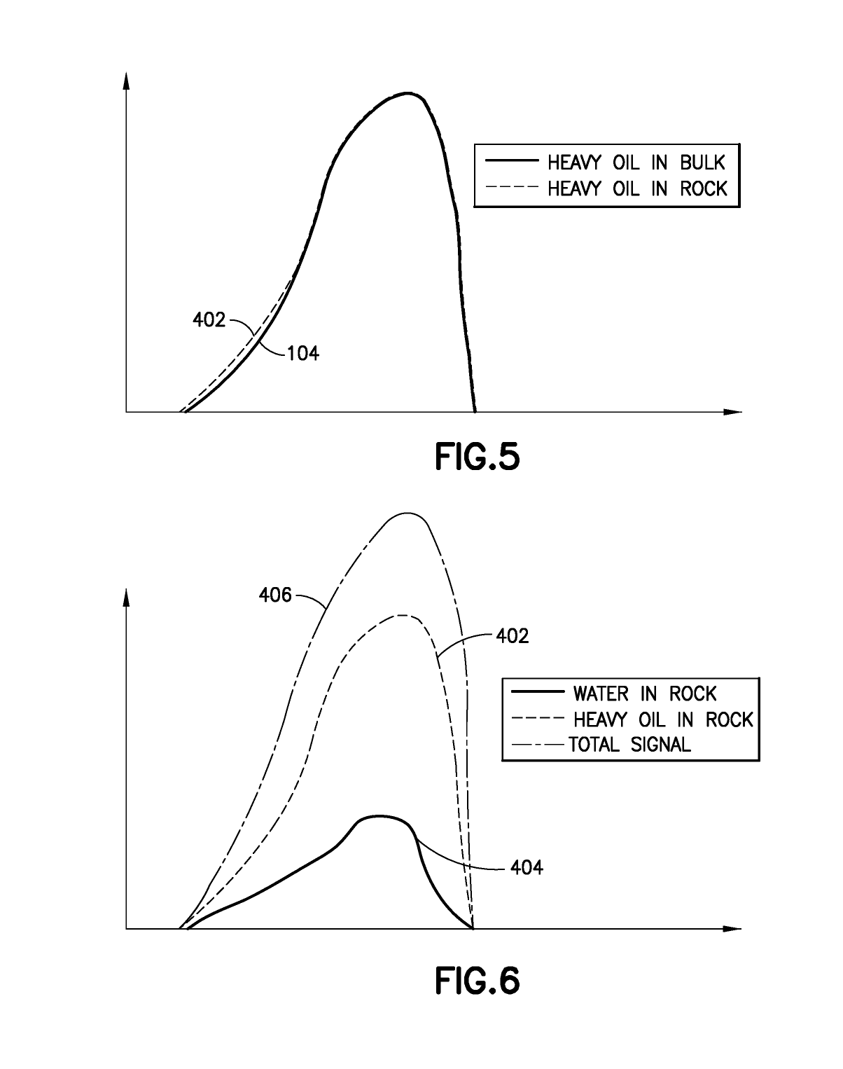

FIG. 6 shows the response (curve 402) of heavy oil in rock (same as that plotted in FIG. 5) plotted along with a response signal (curve 404) of wetting water in rock. Note the two overlap in the T₂ domain (i.e., they have comparable relaxation times). The measured signal (curve 406), therefore, is the sum of those two signal components.

Because heavy oil relaxes with short T₂ times, there are difficulties brought on by physical limitations when studying wettability by NMR. The most common (NMR) technique to determine wettability is to extract the decrease in relaxation time due to surface interactions. The surface interaction effects are superimposed onto the relaxation of the bulk fluid. If the fluid relaxes very fast (for example, because it is heavy oil), the effect of the surface interactions becomes negligible in comparison to the bulk signal. Therefore, it is not possible to quantify the decrease accurately and, by extension, one cannot extract the wettability. This is a common problem for any measurement dealing with sensor saturation or too low a resolution—problems that are effectively the same when trying to measure a tiny variation superimposed on a much larger signal.

The usefulness of the above equations diminishes when:

$$\frac{1}{{T}_{2 , bulk}} ≫ ρ \frac{A}{V} \qquad ( 3 )$$

This limitation implies surface information can be extracted only for those pore sizes for which T_{2, measured} is shorter than T_{2, bulk}. As T_{2, measured} approaches T_{2, bulk}, the sensitivity to surface interactions diminishes, or, stated differently, the sensitivity to surface interactions is greater when the difference between T_{2, measured} and T_{2, bulk} is larger. If the oil is viscous, the T_{2, bulk} is already very short, which affects the sensitivity of the method to wettability. In that case, the ρA/V term is much smaller than the T_{2, bulk} term. In addition, the high viscosity of oil may cause the fast exchange between the oil in the middle of pore and the surface of the pore to break down, making the interpretation of the NMR signal even more complicated and the extraction of wettability information even more difficult.

Very short T₂ values also negatively affect the Diffusion-T₂ based techniques. Diffusion measurement requires a spin to diffuse away from the position at which it was tagged to a new position that alters the NMR signal. The altered NMR signal can be used to estimate diffusion. However, for a fast decaying spin, there is limited time for the molecule (carrying a spin-tagged nucleus) to diffuse before its spin decays below the measurement capability of the instrument. The typical signature of heavy oil on a D-T₂ map is a smeared blob covering all or nearly all of the entire range of diffusion. This makes the position of the oil peak poorly defined, and since the position of the peak is a key input parameter for a D-T₂ based inversion, the wettability determined by this technique will be very unreliable. Even more directly, high viscosity oil, with its associated short T₂ times, may cause the NMR signal itself to fall below the measurement range of the NMR instrument.

In one embodiment a high viscosity fluid in the pore volume is replaced with a fluid without perturbing the wettability of the pore wall, and the wettability measurement is performed over the newly prepared sample. To make the desired measurements in cases for which heavy oil (viscous fluid) is the fluid of interest, the heavy oil phase can be replaced with a lighter oil phase that does not affect the parameter of interest (e.g., wettability of rock). This is achieved by flushing the rock containing the highly viscous oil with a light hydrocarbon that mixes with the native oil and reduces its viscosity. As a result, the heavier oil is, at least partially, removed and replaced with the lighter hydrocarbons. This changes the bulk of the oil in the pore interior but not the oil that may be attached to the pore wall—the part that is responsible for the oil-wetting state of the pore surface. The light hydrocarbon filling the space in the middle of the pore has a longer T_{2,bulk}, which allows both the T₂ shift and the diffusion-based methods to be used. The light oil that is used preferably does not have polar components that can affect the wettability. Light alkanes (for example, dodecane) can be used, as well as others.

Alternatively, while most of the examples discussed herein relate to replacing a viscous fluid with a less viscous fluid, the opposite may be done. More specifically, a fluid having a lower viscosity (e.g., a light oil having a viscosity close to that of water) may yield a poor diffusion contrast between the light oil and water. Thus, to improve the diffusion contrast, a somewhat more viscous fluid could replace the lower viscosity fluid. In addition, while reference may be made to “native” fluid herein, that term is intended to include other fluids such as complex fluids (e.g., emulsified fluids).

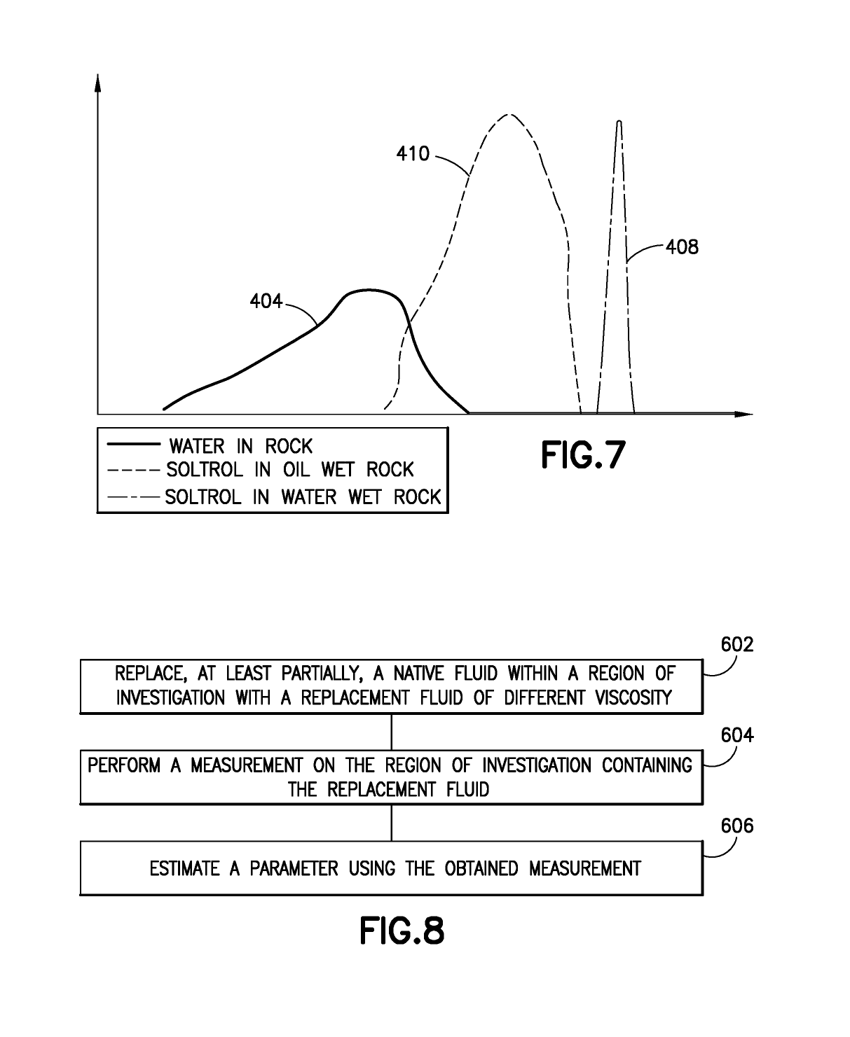

FIG. 7 shows the signal that arises from the same rock measured in FIG. 6 after the heavy oil is replaced by light oil (in this particular case, SOLTROL, a light hydrocarbon mixture of alkenes that is routinely used in the lab). Two different cases are shown in FIG. 7 (along with the water in rock signal, curve 404). If the rock pores containing the light oil are water wet, the oil phase (now light oil rather than heavy oil) relaxes (see curve 408) in a manner similar to light oil in bulk (cf., FIG. 2, curve 106). If instead the pores containing the oil are at least partially oil wet, the light oil experiences enhanced relaxivity (see curve 410) compared to light oil in bulk and comes in at shorter T₂ times. The shape of the T₂ distribution for the wetting SOLTROL depends on saturation and pore size, as is evident from Equation (2). Since the response of the fluid varies depending on the wettability properties of the rock, it is possible to design an inversion algorithm to determine an accurate estimate of wettability.

Displacing and replacing the viscous oil with lighter oil can be done in the laboratory using a core flooding method, wherein light oil is pushed through a core plug at increasingly higher pressures. Alternatively, the core plug can be centrifuged to drive the light oil into the plug and the viscous oil out of the plug, or the core plug can be immersed in light hydrocarbon for an extended duration of time (imbibition). Once the bulk oil has been replaced with light hydrocarbons, standard laboratory techniques such as AH and USBM that rely on moving the oil in and out of the pores can be used. Alternatively, NMR measurements can be used to measure the wettability of the now light oil filled formation sample. The NMR measurement is less time consuming than the standard laboratory methods. As such it can be applied while the fluid replacement is on-going and wettability can be measured while the fluid replacement proceeds until a stable wettability level is achieved.

For downhole applications, the light hydrocarbon can be pushed into the zone of interest by isolating the well with packers and injecting the light hydrocarbon into the space between the packers. “Pressure cycling”, as used herein, means changing the pressure to some desired pressure, making a measurement, and then repeating that process, as desired. The operation can be repeated (i.e., pressure can be varied) until the measured T₂ times of the oil in the formation fall into a practical range. FIG. 3 shows a well 311 drilled in a formation 320 for which it is desired to measure the wettability. If the pore space of the fluid contains a sufficient volume of heavy hydrocarbon or other such fluid having a high viscosity, the measurement of wettability is not a trivial task and may even be impossible to do, as is. To measure the formation wettability, an instrument 340 is lowered into the well 311 to a depth of interest. The instrument 340 is equipped with at least two packers 360a and 360b. These packers are activated, as is well known in the art, to make a hydraulic seal with the formation wall. As a result, the annular space 370 is isolated from the remainder of the well and can be manipulated. Initially, the space 370 may contain drilling fluid. The instrument 340 contains a pumping sub 345 that can be used to evacuate the mud volume (drilling fluid) from the isolated space 370. Next, a light hydrocarbon such as dodecane or the like is pumped into the space 370 by the pumping sub 345 at a pressure higher than the formation pressure. The excess pressure causes the light hydrocarbon to invade the formation 320 and push the native high viscosity fluid further back into the formation, away from the formation wall. The pressure is monitored and maintained by a pressure gauge that is part of the pumping sub 345. As fluid enters the formation and the pressure drops, pumping sub 345 compensates for this loss by pumping light hydrocarbons into the space 370 to maintain the pressure.

The instrument 340 also contains an NMR measuring device 350 with a sensitive region located inside the formation and not in the borehole volume. Such NMR measurement tools already exist commercially for NMR logging. An example is the PROVISION tool offered by the Schlumberger Technology Corporation which has a sensitive region at least one inch (2.54 cm) inside the formation. For different borehole sizes different PROVISION tools are available and can be used. The NMR instrument 350 is used to measure the wettability of the formation as a function of time. At early times the fraction of high viscosity fluid in the pore space may be too high to make any NMR measurements of the wettability. However, as time passes more and more of the pore space fills with the light hydrocarbon, leading to an increase in the NMR signal and the possibility of making wettability measurements. The NMR measurements are continued until the measurement intensity levels off, indicating that the invasion has reached the point for which the heavy hydrocarbon is at a residual saturation level and its concentration cannot be reduced further. The final, leveled-off wettability measurement is taken as the representative wettability of the formation.

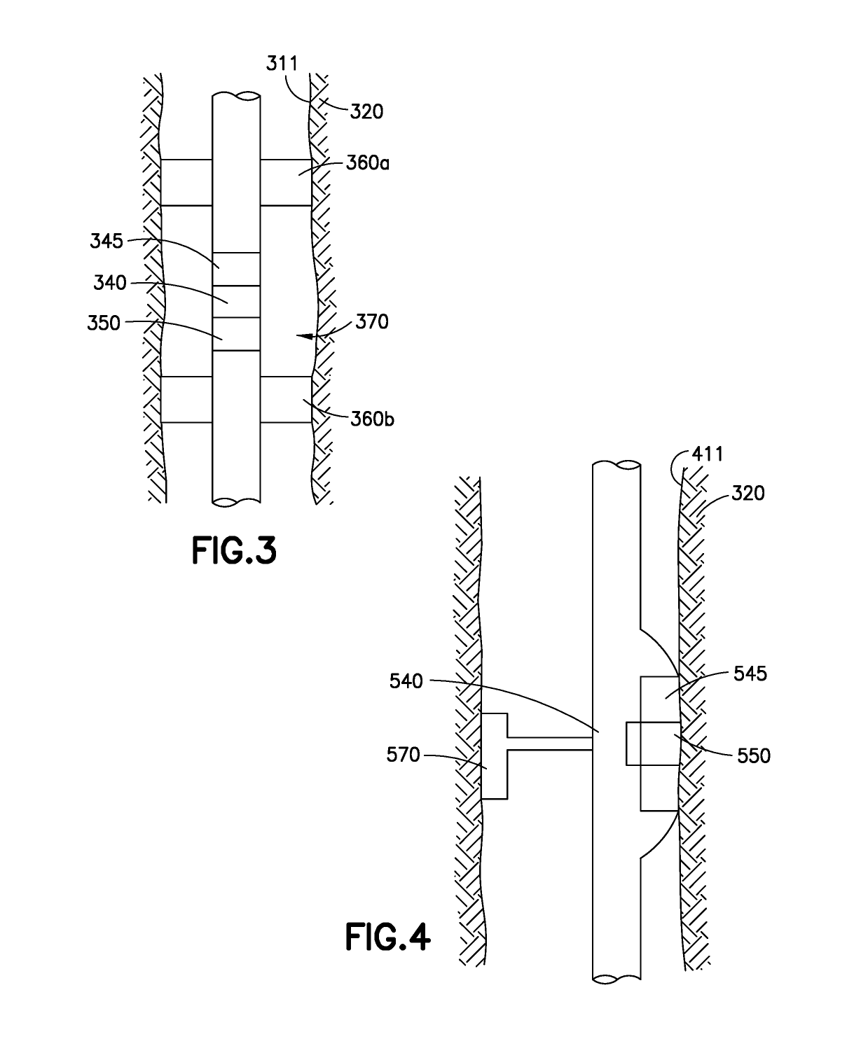

In another embodiment, shown in FIG. 4, the pumping and NMR measurement are done using an instrument 540 that is not centered in the well; rather, it is a pad-type tool. The well 411 is drilled in the formation 320 for which it is desired to measure the wettability. The instrument 540 is delivered to a depth of interest and an arm 570 is actuated to push the pad against the borehole wall. The arm 570 is positioned behind the pad side of the instrument 540 and the force exerted by arm 570 causes the pad to be pressed against the wall with sufficient force to hydraulically seal the pad to the borehole wall. As is known in the art, the face of the instrument 540 may contain elastic sealing rings (such as rubber) to facilitate the sealing. Any small volume of drilling fluid trapped in the small gap between the borehole wall and the face of instrument 540 is pumped out by the pumping unit 545, which is a component of the instrument 540. The pumping unit 545 then applies and maintains a high pressure level of light hydrocarbon to the borehole wall, causing the light hydrocarbon to invade the formation and replace the high viscosity native fluid previously present in the pore space of the formation. As the invasion proceeds an NMR instrument 550 performs NMR measurements and the wettability is determined as a function of time in a manner similar to what was described above.

The choice of oil to replace the heavy oil initially in the formation (i.e., the oil preventing an accurate wettability determination) is relatively unrestricted. The bulk oil T₂ distribution should be different enough from the bulk water T₂ distribution to be able to separate the two fluids on the basis of just T₂ times, if just T₂-based inversion is planned. If other (wettability) inversions are used (for example, restricted diffusion D-T₂), T₂ distribution contrast between bulk oil and bulk water is not strictly required. However, a distinguishing characteristic such as a distinguishable diffusion contrast will be required. The bulk oil T₂ distribution of the replacement oil cannot be too short, else there is no advantage in replacing the native fluid. Experiments have shown a non-polar oil comprising dodecane is a good replacement oil candidate. Its bulk T₂ distribution at normal ambient temperatures is about 800 ms, long enough to give good sensitivity to wettability, but different enough from water (which is about 2-3 seconds at similar conditions) to be distinguishable.

Another positive characteristic for the replacement oil is a sharp (i.e., narrow) T₂ distribution. This typically comes about when the fluid has molecules of similar size. This helps the wettability inversion or, more generally, the interpretation, since the bulk oil properties are consistent. This means that for each molecule of oil having a T₂ value shorter than the bulk value, the T₂ shift is well defined and single-valued. If the bulk T₂ distribution of the replacement oil is very broad, an oil molecule with given T₂ could represent either a light oil molecule (slow relaxing in the bulk) strongly wetting the surface or a heavy oil molecule (fast relaxing in the bulk) weakly wetting the rock surface.

The difference between the T₂ distributions before and after light oil replacement is that with heavy oil the position of the oil signal in the T₂ domain is mainly determined by the bulk properties of the fluid, whereas with light oil, the position of the oil signal is mainly determined by surface interactions.

FIG. 8 shows a flowchart illustrating an embodiment in accordance with this disclosure. In this embodiment, the workflow comprises: replacing a native fluid within a region of investigation with a viscous fluid of different viscosity (602); performing a measurement on the region of investigation containing the replacement fluid (604); and estimating a parameter using the obtained measurement (606).

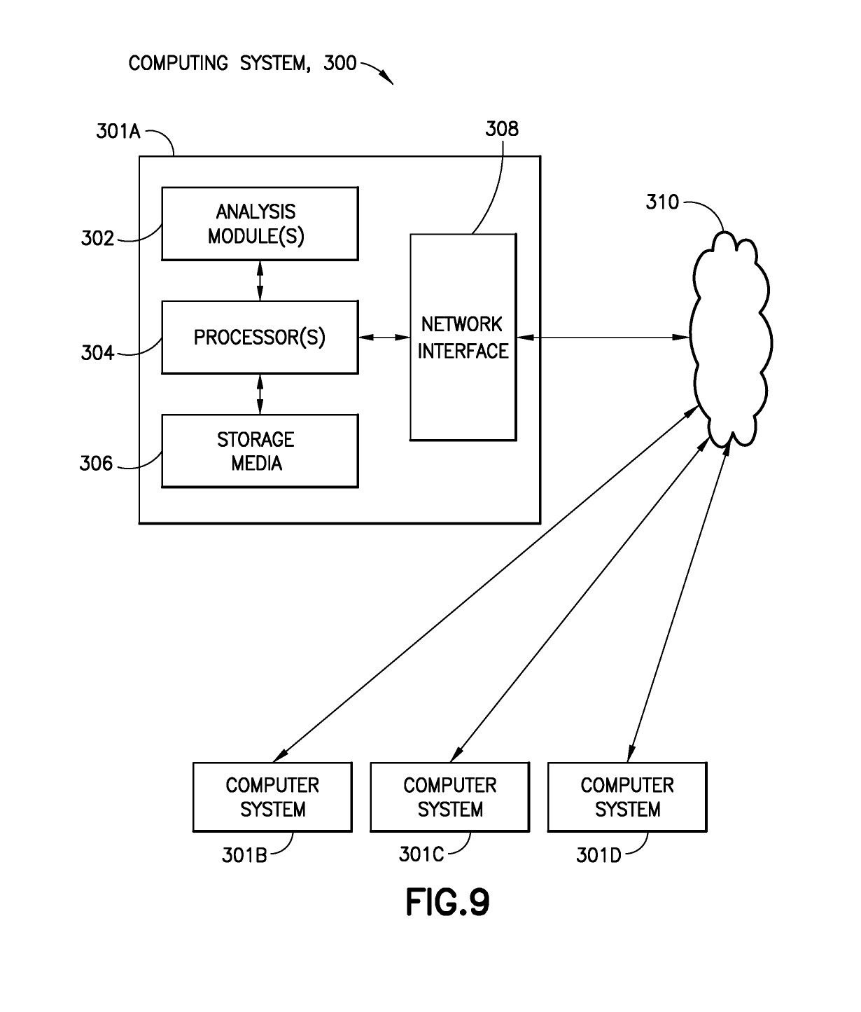

The computing system 300 shown in FIG. 9 can be an individual computer system 301A or an arrangement of distributed computer systems. The computer system 301A includes one or more analysis modules 302 that are configured to perform various tasks according to some embodiments, such as one or more methods disclosed herein (e.g., any of the steps, methods, techniques, and/or processes, and/or combinations and/or variations and/or equivalents thereof). To perform those various tasks, analysis module 302 operates independently or in coordination with one or more processors 304 that is (or are) connected to one or more storage media 306. The processor(s) 304 is (or are) also connected to a network interface 308 to allow the computer system 301A to communicate over a data network 310 with one or more additional computer systems and/or computing systems, such as 301B, 301C, and/or 301D (note that computer systems 301B, 301C, and/or 301D may or may not share the same architecture as computer system 301A, and may be located in different physical locations, while in communication with one or more computer systems such as 301C and/or 301D that are located in one or more data centers onshore, on other ships, and/or located in various countries on different continents).

The storage media 306 can be implemented as one or more computer-readable or machine-readable storage media. Note that while in the example embodiment of FIG. 9 storage media 306 is depicted as within computer system 301A, in some embodiments, storage media 306 may be distributed within and/or across multiple internal and/or external enclosures of computing system 301A and/or additional computing systems. Storage media 306 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 300 is only one example of a computing system, and that computing system 300 may have more or fewer components than shown, may combine additional components not depicted in the example embodiment of FIG. 9, and/or computing system 300 may have a different configuration or arrangement of the components depicted in FIG. 9. For example, though not shown explicitly, computing system 300 would generally include input and output devices such as a keyboard, a mouse, a display monitor, and a printer and/or plotter. The various components shown in FIG. 9 may be implemented in hardware, software, or a combination of both hardware and software, including one or more signal processing and/or application specific integrated circuits.

A processor can include a microprocessor, microcontroller, processor module or subsystem, programmable integrated circuit, programmable gate array, or another control or computing device. Further, the steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of this disclosure.

Some of the embodiments described above can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). At least some of the embodiments described above can be implemented using such logic devices.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the scope of the present disclosure, and that they may make various changes, substitutions, and alterations herein without departing from the scope of the present disclosure.

The Abstract at the end of this disclosure is provided to comply with 37 C.F.R. § 1.72(b) to allow the reader to quickly ascertain the nature of the technical disclosure. It is submitted with the understanding that it will not be used to interpret or limit the scope or meaning of the claims.

While only certain embodiments have been set forth, alternatives and modifications will be apparent from the above description to those skilled in the art. These and other alternatives are considered equivalents and within the scope of this disclosure and the appended claims. Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A system, comprising:
a measurement device;
a replacement fluid disposed in a region of investigation, replacing native fluid in the region of investigation, wherein the replacement fluid has a different viscosity than the native fluid; and
a processor capable of estimating a parameter using data obtained by the measurement device regarding the region of investigation having the replacement fluid.

2. The system of claim 1, wherein the measurement device is selected from a group consisting of an NMR device and a fluid application, fluid collection, and volumetric measurement system.

3. The system of claim 1, wherein the replacement fluid is selected from a group consisting of one or more alkanes, one or more alkenes, and a mixture of alkanes and alkenes.

4. The system of claim 1, wherein the replacement fluid is non-polar.

5. The system of claim 1, wherein the parameter estimated is selected from a group consisting of wettability and relaxivity.

6. The system of claim 1, wherein the measurement device and the processor are disposed in a wellbore.

7. The system of claim 6, further comprising a pair of packers disposed in the wellbore to isolate the region of investigation.

8. A method, comprising:
replacing, at least partially, a native fluid within a region of investigation with a replacement fluid, wherein the replacement fluid is of different viscosity than the native fluid;
performing a measurement on the region of investigation containing the replacement fluid; and
estimating a parameter using the obtained measurement.

9. The method of claim 8, wherein the replacement fluid is selected from a group consisting of one or more alkanes, one or more alkenes, and a mixture of alkanes and alkenes.

10. The method of claim 8, wherein the performing a measurement comprises performing a measurement selected from a group consisting of a nuclear magnetic resonance measurement and a volumetric measurement of collected fluid.

11. The method of claim 8, wherein the estimating a parameter comprises using a technique selected from a group consisting of the Amott-Harvey technique, the United States Bureau of Mines technique, a T₂ based inversion, and a diffusion-T₂ based inversion.

12. The method of claim 8, wherein the parameter estimated is selected from a group consisting of wettability and relaxivity.

13. The method of claim 8, wherein the estimated parameter is wettability, the obtained measurement is an NMR measurement, and further comprising extracting a decrease in relaxation time due to surface interactions to estimate the wettability.

14. The method of claim 8, wherein the replacing of the native fluid is achieved by core flooding, pressure cycling, centrifuging, or imbibition.

15. The method of claim 8, wherein the replacing, at least partially, a native fluid within a region of investigation with a replacement fluid comprises forming a mixture of the native fluid and the replacement fluid that has a viscosity that is different than the viscosity of the native fluid.

16. A method, comprising:
causing a replacement fluid to at least partially displace and replace a native fluid within a region of investigation, wherein the replacement fluid is of different viscosity than the native fluid;
performing a nuclear magnetic resonance (NMR) measurement on the region of investigation containing the replacement fluid; and
correlating the obtained NMR measurement to a bulk fluid NMR measurement; and
estimating a parameter using the obtained correlation.

17. The method of claim 16, wherein the replacing of the native fluid is achieved by core flooding, pressure cycling, centrifuging, or imbibition.

18. The method of claim 16, wherein the parameter estimated is selected from a group consisting of wettability and relaxivity.

19. The method of claim 16, wherein the correlating comprises comparing an inversion performed on the obtained NMR measurement to a corresponding inversion performed on a corresponding bulk fluid NMR measurement.

20. The method of claim 16, wherein the correlating comprises identifying an enhanced relaxation time for the obtained NMR measurement relative to a corresponding bulk fluid NMR measurement.
